(19) United States
(12) Patent Application Publication
(10) Pub. No.: US 2025/0368270 A1
(43) Pub. Date: Dec. 4, 2025

(54) ROOF MODULE

(71) Applicant: TOYODA GOSEI CO., LTD., Kiyosu-shi (JP)

(72) Inventors: Kazuhisa TAKAHASHI, Kiyosu-shi (JP); Koji FUKAGAWA, Kiyosu-shi (JP)

(21) Appl. No.: 19/184,194

(22) Filed: Apr. 21, 2025

(30) Foreign Application Priority Data
May 29, 2024 (JP) 2024-087198

(51) Int. Cl. B62D 25/06; B60Q 3/54; B60R 11/04

(52) U.S. Cl. CPC B62D 25/06; B60Q 3/54; B60R 11/04; B60R 2300/8093; B60Y 2400/3015; B60Y 2400/3017

(57) ABSTRACT

A roof module includes a panel member, a sensor unit arranged towards an outer side of a vehicle from the panel member, a sensor cover covering the sensor unit, a lamp unit arranged towards an inner side of the vehicle from the panel member, and an inner cover covering the lamp unit. The sensor cover is adjacent to a windshield of the vehicle and a surface of the sensor cover is flush with a surface of the windshield.

### CROSS-REFERENCE TO RELATED APPLICATIONS

This application is based upon and claims the benefit of priority from Japanese Patent Application No. 2024-087198, filed on May 29, 2024, the entire contents of which are incorporated herein by reference.

### BACKGROUND

### 1. Field

The following description relates to a roof module coupled to a vehicle.

### 2. Description of Related Art

Japanese Patent No. 7311616 discloses a known example of a roof module. The roof module includes a sensor module. The sensor module includes an ambient sensor that detects the ambient environment of a vehicle so that the vehicle can perform autonomous driving. The sensor module is covered by a roof skin. A step is formed in the roof skin at an area corresponding to the sensor module. A front surface of the step defines a see-through portion. The see-through portion is transparent and allows for the transmission of electromagnetic waves in a wavelength range used by the ambient sensor.

The roof module includes the step which is formed on the roof skin that covers the sensor module. Thus, the air flowing along an outer surface of the traveling vehicle strikes the step. This disturbs the airflow and adversely affects the aerodynamic characteristics of the vehicle.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a roof module is coupled to a roof frame of a vehicle. The roof module includes a panel member, a sensor unit arranged towards an outer side of the vehicle from the panel member, a sensor cover covering the sensor unit, a lamp unit arranged towards an inner side of the vehicle from the panel member, and an inner cover covering the lamp unit. The sensor cover is adjacent to a windshield of the vehicle. The sensor cover includes a surface that is flush with a surface of the windshield.

Other features and aspects will be apparent from the following detailed description, the drawings, and the claims.

### BRIEF DESCRIPTION OF THE DRAWINGS

FIG. 1 is a perspective view of a part of a vehicle where a roof module is attached.

FIG. 2 is an enlarged cross-sectional view of FIG. 1.

FIG. 3 is an exploded cross-sectional view of the roof module attached to the vehicle.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

One embodiment will now be described with reference to the drawings. In the description hereafter, the direction in which a vehicle 11 travels forward is hereinafter referred to as the front, and the reverse direction is hereinafter referred to as the rear. Moreover, the up-down direction refers to the up-down direction of the vehicle, and the left-right direction refers to a vehicle width direction that corresponds with the left-right direction when the vehicle 11 is traveling forward.

### Vehicle 11

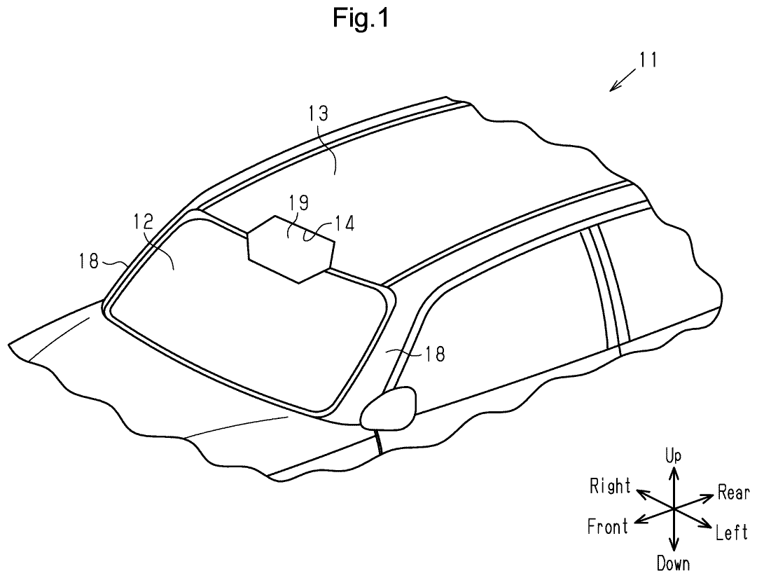

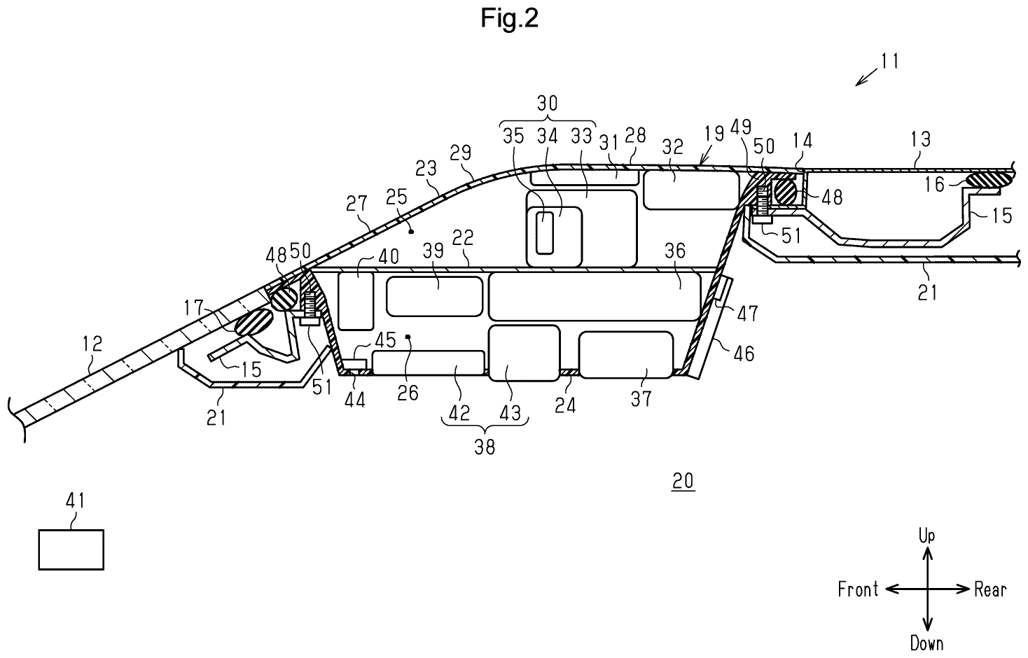

As shown in FIGS. 1 and 2, the vehicle 11 includes a windshield 12, a roof panel 13, and an open portion 14. The windshield 12 is an example of a window. The open portion 14 is arranged at the central part of the vehicle 11 in the vehicle width direction, and extends across the windshield 12 and the roof panel 13. A roof frame 15, which has a closed form, surrounds the open portion 14 of the vehicle 11. A seal for metal plate 16 is arranged between the roof frame 15 and the roof panel 13. A glass sealant 17 is arranged between the roof frame 15 and the windshield 12.

A part of the roof frame 15 extends in the vehicle width direction and includes two ends respectively coupled to an A-pillar 18 connected to a body frame (not shown). A roof module 19 is fitted into the open portion 14 of the vehicle 11. In other words, the roof module 19 is coupled to the roof frame 15 in a state fitted into the open portion 14. The roof frame 15 is covered by an interior panel 21 that is arranged in a passenger compartment 20. Therefore, the roof frame 15 is concealed by the interior panel 21 in the passenger compartment 20.

### Roof Module 19

As shown in FIG. 2, the roof module 19 includes a panel member 22, a sensor cover 23, and an inner cover 24.

The inner cover 24, which is formed from a synthetic resin, is box-shaped and has an open upper end and a closed lower end. The sensor cover 23, which is a sheet of synthetic resin that transmits visible light, is attached to the inner cover 24 to cover the open upper end of the inner cover 24.

The panel member 22 is arranged to divide the space enclosed, by the inner cover 24 and the sensor cover 23, into an upper compartment 25 and a lower compartment 26 that are arranged one above the other. In other words, the panel member 22 acts as a partition that completely separates the upper compartment 25 and the lower compartment 26. The upper compartment 25 is located towards an outer side of the vehicle from the panel member 22. The lower compartment 26 is located towards an inner side of the vehicle from the panel member 22. The panel member 22 is formed from a metal having high thermal conductivity, such as aluminum or copper.

The sensor cover 23 includes an inclined portion 27 that is located toward the front from the central part of the sensor cover 23 with respect to the front-rear direction. The sensor cover 23 is inclined downwardly toward the front. The sensor cover 23 includes a substantially horizontal flat portion 28 that is located toward the rear of the central part with respect to the front-rear direction. The sensor cover 23 includes a curved portion 29 that is located at the central part with respect to the front-rear direction. The curved portion 29 is curved so as to bulge toward the outer side of the vehicle. The inclined portion 27 and the flat portion 28 are connected by the curved portion 29. The inclined portion 27, the flat portion 28, and the curved portion 29 are formed integrally.

The inclined portion 27 is adjacent to the windshield 12. The surface of the inclined portion 27 forming the outer surface of the vehicle is flush with the surface of the windshield 12 forming the outer surface of the vehicle. The flat portion 28 is adjacent to the roof panel 13. The surface of the flat portion 28 forming the outer surface of the vehicle is flush with the surface of the roof panel 13 forming the outer surface of the vehicle.

Accordingly, the surface of the sensor cover 23 is flush with both the surface of the roof panel 13 and the surface of the windshield 12. Therefore, no step is formed between the sensor cover 23 and the roof panel 13, and between the sensor cover 23 and the windshield 12.

### Upper Compartment 25

As shown in FIG. 2, the upper compartment 25 is sealed by the inner cover 24, the sensor cover 23, and the panel member 22. The upper compartment 25 includes a sensor unit 30, an external lamp 31, and an external antenna 32. The sensor cover 23 covers the sensor unit 30, the external lamp 31, and the external antenna 32, which are arranged in the upper compartment 25.

The sensor unit 30 is fixed in a state of contact with the panel member 22. The sensor unit 30 faces the inclined portion 27 of the sensor cover 23 in the front-rear direction. The sensor unit 30 includes a Light Detection and Ranging (LiDAR) 33, a millimeter wave radar 34, and an external camera 35.

The LiDAR 33 emits a laser beam toward the front that bounces when striking an object, such as a front vehicle, and measures the time elapsed from when the laser beam was emitted to when the laser beam returned to detect the distance to the object and/or the direction toward the object. The millimeter wave radar 34 emits millimeter waves toward the front that bounce back when striking an object, such as the front vehicle, and measures the time elapsed from when the laser beam was emitted to when the laser beam returned to detect the distance to the object and/or the direction toward the object. The external camera 35 captures images of objects and pedestrians in front of the vehicle 11.

The external lamp 31 is arranged above the sensor unit 30 in the upper compartment 25. An example of the external lamp 31 is an autonomous driving indicator lamp that is turned on when the vehicle 11 is being driven autonomously.

The external antenna 32 is arranged at the back of the external lamp 31 of the upper compartment 25. Examples of the external antenna 32 include a 5G or 6G GHz antenna (V2X), an Electronic Toll Collection (ETC) antenna, a MHz antenna for remote control keys, a television and radio antenna, a Global Positioning System (GPS) antenna, and a Wi-Fi (registered trademark) antenna.

### Lower Compartment 26

As shown in FIG. 2, the lower compartment 26 includes a control unit 36, a microphone speaker 37, a lamp unit 38, an internal antenna 39, and a thermal sensor 40. The inner cover 24 covers the control unit 36, the microphone speaker 37, the lamp unit 38, the internal antenna 39, and the thermal sensor 40, which are arranged in the lower compartment 26.

The control unit 36 is fixed at the upper rear part of the lower compartment 26 in a state of contact with the panel member 22. The control unit 36 controls the entire roof module 19 including the sensor unit 30. The sensor unit 30 remotely controls an air conditioner 41, which is installed inside an instrument panel (not shown), through wireless communication.

The microphone speaker 37 is arranged below the control unit 36 in the lower compartment 26. A part of the microphone speaker 37 is exposed from a lower wall of the inner cover 24 in the passenger compartment 20. The microphone speaker 37 is set, for example, to be connected to a mobile phone in a manner allowing for hands-free calling. The microphone speaker 37 is set, for example, to be connected to a car navigation system (not shown) installed in the vehicle 11 in a manner allowing for voice assistance and/or voice operation of the car navigation.

The lamp unit 38 is arranged in the lower compartment 26 in front of the microphone speaker 37. The lamp unit 38 includes an internal lamp 42 and an operating switch 43 that is arranged between the internal lamp 42 and the microphone speaker 37. The internal lamp 42 includes, for example, an interior light or an interior illumination lamp that illuminates the interior of the passenger compartment 20. The operating switch 43 is used to turn on or turn off the internal lamp 42. A part of the internal lamp 42 and the operating switch 43 are exposed from the lower wall of the inner cover 24 in the passenger compartment 20.

The internal antenna 39 is arranged in the lower compartment 26 in front of the control unit 36. The internal antenna 39 may include for example, a Wi-Fi (registered trademark) antenna, a Bluetooth (registered trademark) antenna, a Near Field Communication (NFC) antenna, or the like.

The thermal sensor 40 is arranged in the lower compartment 26 in front of the internal antenna 39 and is fixed in a state of contact with the panel member 22. The thermal sensor 40 detects the temperature of the panel member 22. The thermal sensor 40 sends the temperature detection result to the control unit 36.

The inner cover 24 includes the lower compartment 26 that is in communication with the passenger compartment 20 through one or more through holes 44. More specifically, the inner cover 24 includes, for example, a mesh-like pattern of through holes 44. The through holes 44 are covered by a filter 45 arranged on the inner cover 24 in the lower compartment 26. Thus, the filter 45 filters the air that flows from the through holes 44 to the lower compartment 26.

A monitor 46 and an internal camera 47 are arranged on the back of the inner cover 24 at an area corresponding to the lower compartment 26. The monitor 46 displays the images captured by a rearview camera (not shown), which is arranged at the back of the vehicle 11. The monitor 46 has the functionality of an electronic rearview mirror. The internal camera 47 captures images of the passenger compartment 20.

### Method for Attaching the Roof Module 19 to the Vehicle 11

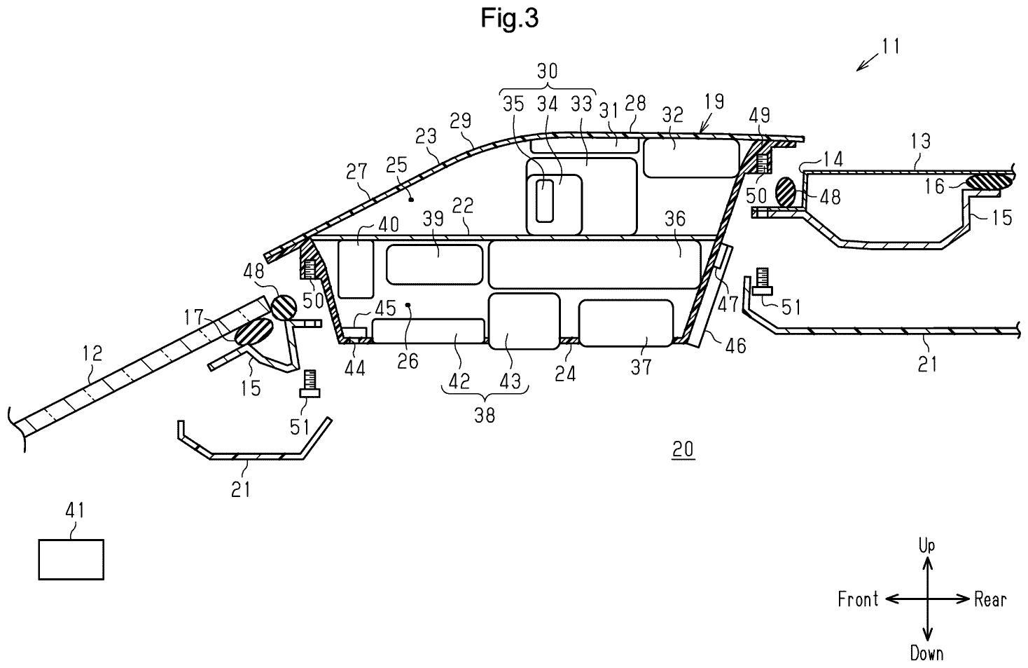

As shown in FIG. 3, when attaching the roof module 19 to the vehicle 11, a looped waterproof sealing member 48 is first arranged on the roof frame 15. Then, the roof module 19 is fitted into the open portion 14 of the vehicle 11 from the outer side of the vehicle. Consequently, as shown in FIG. 2, the roof frame 15 supports a peripheral portion 49 of the roof module 19 with the waterproof sealing 48 located between the peripheral portion 49 of the roof module 19 and the roof frame 15.

In this state, bolts 51 extending through the roof frame 15 are fastened to female threaded portions 50 arranged at intervals in the peripheral portion 49 of the roof module 19, from the inner side of the vehicle. Some of the bolts 51 fastened to the female threaded portions 50 in the peripheral portion 49 of the roof module 19 extend through the roof frame 15 and through the roof panel 13. Therefore, these bolts 51 fasten together the roof frame 15 and the roof panel 13 to the female threaded portions 50.

Accordingly, the roof module 19 is attached to the roof frame 15 at the peripheral portion 49. In this case, the roof module 19 is mechanically fastened to the roof frame 15, which forms a frame of the vehicle 11. This will keep the devices in the sensor unit 30 aligned. Subsequently, the roof module 19 is wired, and the interior panel 21 is attached to the vehicle 11 from the inner side of the vehicle to conceal the roof frame 15 and the bolts 51. This completes the attachment of the roof module 19 to the vehicle 11.

The operation of the present embodiment will now be described.

Air flows sequentially along the surface of the windshield 12, the surface of the sensor cover 23 of the roof module 19, and the surface of the roof panel 13, when the vehicle 11 travels. The surface of the windshield 12, the surface of the sensor cover 23 of the roof module 19, and the surface of the roof panel 13 of the vehicle 11 form a seamless surface that is free from steps. Therefore, the seamless surface will not disturb the flow of the air, and the aerodynamic characteristics of the traveling vehicle 11 will thus be improved.

If the roof module 19 were to be attached to the vehicle 11 in a state in which the roof module 19 projects out of the surface of the vehicle 11, steps would be formed by the roof module 19 at the windshield 12 and the roof panel 13. The steps would disturb the air flowing along the surface of the traveling vehicle and adversely affect the aerodynamic characteristics of the vehicle 11.

Moreover, when the outside temperature of the traveling vehicle 11 is high or low, the temperature of the sensor unit 30 of the roof module 19 may fall outside the operating temperature range. Therefore, the control unit 36 constantly recognizes the temperature of the panel member 22 based on the thermal detection results sent from the thermal sensor 40.

If the control unit 36 recognizes that the temperature of the panel member 22 falls out of the operating temperature range of the sensor unit 30, the control unit 36 remotely controls and drives an air conditioner 41 to send warm air or cool air to the roof module 19 so that the temperature of the panel member 22 falls within the operating temperature range of the sensor unit 30. In this case, the warm air or cool air is blown out from an air outlet of a defroster of the air conditioner 41 into the roof module 19.

The warm air or cool air sent to the roof module 19 is filtered by the filter 45 as the air flows from the through holes 44 into the lower compartment 26. The warm air or cool air that flows to the lower compartment 26 warms or cools the panel member 22. Moreover, the warmed or cooled panel member 22 exchanges heat with the sensor unit 30. As a result, the temperature of the sensor unit 30 is controlled to be within the operating temperature range. This allows the sensor unit 30 to maintain normal operation.

The advantages of the present embodiment will now be described.

(1) In the roof module 19, the sensor cover 23 is adjacent to the windshield 12 of the vehicle 11, and the surface of the sensor cover 23 is flush with the surface of the windshield 12.

This structure forms a seamless surface that is free from steps between the surface of the sensor cover 23 and the surface of the windshield 12. Thus, air flows along the seamless surface without being disturbed when the vehicle 11 travels. This further improves the aerodynamic characteristics of the vehicle 11.

(2) In the roof module 19, the sensor cover 23 is adjacent to the roof panel 13 of the vehicle 11, and the surface of the sensor cover 23 is flush with the surface of the roof panel 13.

This forms a seamless surface that is free from steps between the surface of the sensor cover 23 and the surface of the roof panel 13. Thus, air flows along the seamless surface without being disturbed when the vehicle 11 travels. This further improves the aerodynamic characteristics of the vehicle 11.

(3) In the roof module 19, the inner cover 24 includes the through holes 44.

This structure allows the air from the air conditioner 41 of the vehicle 11 to flow through the through holes 44 to the inner cover 24 into the lower compartment 26. Therefore, the temperature of the sensor unit 30 can be controlled by the air conditioner 41.

(4) In the roof module 19, the panel member 22 is a partition that separates the sensor unit 30 from the lamp unit 38.

The panel member 22 restricts the flow of air from the passenger compartment 20 via the lower compartment 26 to the upper compartment 25, which includes the sensor unit 30. This limits condensation on the inner surface of the sensor cover 23 caused by the moisture in the air of the passenger compartment 20.

### Modifications

The above-described embodiment may be modified as follows. The above-described embodiment and the following modifications can be combined as long as the combined modifications remain technically consistent with each other.

The panel member 22 does not need to separate the sensor unit 30 from the lamp unit 38. In other words, the panel member 22 does not need to completely separate the sensor unit 30 from the lamp unit 38.

The through holes 44 may be omitted from the inner cover 24.

The surface of the sensor cover 23 does not need to be flush with the surface of the roof panel 13.

The open portion 14, into which the roof module 19 is fitted, may be arranged in only the windshield 12 of the vehicle 11. This structure allows the surface of the sensor cover 23 of the roof module 19, which is fitted into the open portion 14, to be wiped with a wiper of the windshield 12.

The open portion 14, into which the roof module 19 is fitted, may be arranged so that the open portion 14 extends over the roof panel 13 and a rear windshield. In this case, the roof module 19, which is fitted into the open portion 14, may include a rear antenna and/or a high-mount stop lamp.

The open portion 14, into which the roof module 19 is fitted, may be arranged in only the rear windshield of the vehicle 11. This structure allows the surface of the sensor cover 23 in the roof module 19, which is fitted into the open portion 14, to be wiped with the wiper for the rear windshield.

The roof module 19 may be fitted into the open portion 14 of the vehicle 11 from the inner side of the vehicle.

In the roof module 19, a dehumidifier or a dehumidifying agent may be arranged in the upper compartment 25, in which the sensor unit 30 is arranged. This decreases the humidity of the upper compartment 25 and limit condensation on the inner surface of the sensor cover 23.

If the temperature of the sensor unit 30 and the control unit 36 increases, the panel member 22 may be used as a heat sink for the sensor unit 30 and the control unit 36. In this case, the air conditioner 41 does not need to be used to cool the sensor unit 30 and the control unit 36.

A nozzle may be arranged in the passenger compartment 20 to direct air currents from the air conditioner 41 into the roof module 19.

The roof module 19 may additionally include Peltier element and/or a Positive Temperature Coefficient (PTC) heater to enhance the temperature control functionality of the roof module 19.

The flat portion 28 of the sensor cover 23 does not need to transmit visible light, and the flat portion 28 may have, for example, the same color as the roof panel 13.

The roof module 19 may include a dashcam camera, an external air temperature sensor, an illuminance sensor, an external speaker, a snow-melting heater, a washer for the sensor cover 23, an air blower for the sensor cover 23, a wiper for the sensor cover 23, an infrared camera, an infrared lamp, an infrared sensor, a temperature sensor for the passenger compartment 20, a rearview mirror monitor, sideview mirror monitor, an entertainment projector, an emergency notification device, various types of switches, a touch panel, a touch monitor, a USB port, and an HDMI (registered trademark) terminal, or the like.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. A roof module coupled to a roof frame of a vehicle, the roof module comprising:
a panel member;
a sensor unit arranged towards an outer side of the vehicle from the panel member;
a sensor cover covering the sensor unit;
a lamp unit arranged towards an inner side of the vehicle from the panel member; and
an inner cover covering the lamp unit, wherein
the sensor cover is adjacent to a windshield of the vehicle, and
the sensor cover includes a surface that is flush with a surface of the windshield.

2. The roof module according to claim 1, wherein
the sensor cover is adjacent to a roof panel of the vehicle, and
the surface of the sensor cover is flush with a surface of the roof panel.

3. The roof module according to claim 1, wherein the inner cover includes a through hole.

4. The roof module according to claim 1, wherein the panel member includes a partition which separates the sensor unit and the lamp unit.
